(19) United States
(12) Patent Application Publication
(10) Pub. No.: US 2019/0065355 A1
(43) Pub. Date: Feb. 28, 2019

(54) INFORMATION PROCESSING DEVICE AND OUTPUT METHOD

(71) Applicant: FUJITSU LIMITED, Kawasaki-shi (JP)

(72) Inventors: Tomoaki Yamamoto, Hamamatsu (JP); Kouji Sasaki, Iwata (JP); Kazunori Kurata, Hamamatsu (JP); Kensuke Horita, Hamamatsu (JP); Hitoshi Saito, Iwata (JP); Taichi Yamamura, Hamamatsu (JP)

(73) Assignee: FUJITSU LIMITED, Kawasaki-shi (JP)

(21) Appl. No.: 16/107,245

(22) Filed: Aug. 21, 2018

(30) Foreign Application Priority Data
Aug. 23, 2017 (JP) 2017-159913

(51) Int. Cl. G06F 11/36; G06F 8/71

(52) U.S. Cl. CPC G06F 11/3688; G06F 8/71; G06F 11/3692

(57) ABSTRACT

There is provided a computer-readable non-transitory recording medium storing a program that causes a computer to execute a procedure that outputs results of a plurality of tests performed on source code, the procedure includes acquiring prior-to-change source code and after-change source code, comparing the acquired prior-to-change source code and after-change source code, identifying changed processing content indicating processing content that has changed between the prior-to-change source code and the after-change source code based on results of comparing, and outputting, in association with the plurality of tests, information indicating test results for the prior-to-change source code, test results for the after-change source code, and changed processing content executed by the plurality of tests for the after-change source code out of the identified changed processing content.

### CROSS-REFERENCE TO RELATED APPLICATION

This application is based upon and claims the benefit of priority of the prior Japanese Patent Application No. 2017-159913, filed on Aug. 23, 2017, the entire contents of which are incorporated herein by reference.

### FIELD

The embodiments discussed herein are related to an information processing device and output method.

### BACKGROUND

For example, a method known as “divergence development” is used in the development of software. Divergence development is a software development method in which existing software is utilized. In divergence development, parts of the existing software are changed.

In divergence development, a fault (degradation) in part of the existing software that has changed may affect other parts of the software. Therefore, in divergence development, testing known as “regression testing” is performed in order to verify whether there are faults. In such regression testing, prior-to-change software and an after-change program are tested, and whether there are differences between the test results is verified.

Japanese Laid-open Patent Publication No. 2016-18390 and Japanese Laid-open Patent Publication No. 2016-167180 are examples of the related art.

### SUMMARY

According to an aspect of the invention, a computer-readable non-transitory recording medium storing a program that causes a computer to execute a procedure that outputs results of a plurality of tests performed on source code, the procedure includes acquiring prior-to-change source code and after-change source code, comparing the acquired prior-to-change source code and after-change source code, identifying changed processing content indicating processing content that has changed between the prior-to-change source code and the after-change source code based on results of comparing, and outputting, in association with the plurality of tests, information indicating test results for the prior-to-change source code, test results for the after-change source code, and changed processing content executed by the plurality of tests for the after-change source code out of the identified changed processing content.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing device;

FIGS. 2A and 2B are diagrams illustrating examples of source code;

FIG. 3 is a diagram illustrating an example of a correspondence relationship table;

FIG. 4 is a diagram illustrating an example of a determination table;

FIG. 5 is a diagram illustrating an example of analysis data;

FIG. 6 is a diagram illustrating an example of an analysis data;

FIG. 7 is a diagram illustrating an example of a correspondence relationship table;

FIG. 8 is a diagram illustrating an example of execution path identification;

FIG. 9 is a diagram illustrating an example of a correspondence relationship table;

FIG. 10 is a diagram illustrating an example of a grouping table;

FIGS. 11A and 11B are diagrams illustrating examples of source code;

FIG. 12 is a diagram illustrating an example of a determination table;

FIG. 13 is a diagram illustrating an example of analysis data;

FIG. 14 is a diagram illustrating an example of analysis data;

FIG. 15 is a diagram illustrating an example of a correspondence relationship table;

FIG. 16 is a diagram illustrating an example of symbolic execution;

FIG. 17 is a diagram illustrating an example of a correspondence relationship table;

FIG. 18 is a diagram illustrating an example of a grouping table;

FIGS. 19A and 19B are diagrams illustrating examples of source code;

FIG. 20 is a diagram illustrating an example of a determination table;

FIGS. 21A and 21B are diagrams illustrating examples of source code;

FIG. 22 is a diagram illustrating an example of a determination table;

FIG. 23 is a flowchart illustrating an example of the flow of processing of an embodiment;

FIG. 24 is a flowchart illustrating an example of the flow of processing of the embodiment;

FIG. 25 is a flowchart illustrating an example of the flow of grouping processing; and

FIG. 26 is a diagram illustrating an example of the hardware configuration of an information processing device.

### DESCRIPTION OF EMBODIMENT

In regression testing, when the test results of a program being tested indicate that there is a difference in the program being tested between before the program was changed and after the program was changed, there is a possibility that there is degradation in the program being tested, and verification of the program being tested is performed.

Even in the case where the test results indicate that there is a difference in the program being tested between before the program was changed and after the program was changed, there is the possibility that the difference is due to an intentional change such as correction of a bug. Therefore, in regression testing, a verifier performs verification of the program being tested through visual inspection.

This verification is performed by the verifier checking each line of the source code by carrying out a visual inspection, for example. A plurality of parameters are used in the verification. Therefore, there is a problem in that the testing work load increases as the number of parameters increases. This problem may also occur in program testing other than regression testing.

Example of System of Embodiment

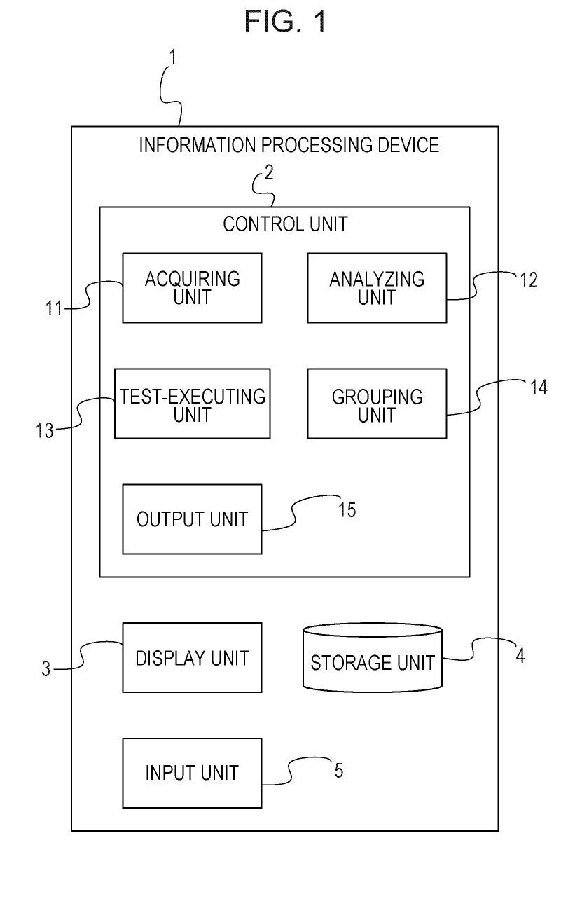

Hereafter, an embodiment will be described while referring to the drawings. FIG. 1 illustrates an example of an information processing device 1 of this embodiment. The information processing device 1 may be a personal computer or a mobile terminal, for example. The information processing device 1 is an example of a computer.

The information processing device 1 includes a control unit 2, a display unit 3, a storage unit 4, and an input unit 5. The control unit 2 performs various types of processing relating to the embodiment. The display unit 3 displays prescribed information on a screen based on control performed by the control unit 2. The storage unit 4 stores various types of information. The input unit 5 is used to input prescribed information.

The control unit 2 includes an acquiring unit 11, an analyzing unit 12, a test-executing unit 13, a grouping unit 14, and an output unit 15. The acquiring unit 11 acquires prior-to-change source code and after-change source code from the storage unit 4.

In this embodiment, it is supposed that testing is performed in divergence development in which software is developed based on new source code obtained by making the source code of an existing program diverge and changing parts of the source code. This testing may be referred to as regression testing. The embodiment is not limited to regression testing in divergence development. For example, the embodiment may be applied to arbitrary testing performed when parts of source code have been changed.

“Prior-to-change source code” is existing source code in divergence development, for example. “After-change source code” is source code obtained by changing parts of the prior-to-change source code. For example, the input unit 5 may be used to make the changes.

In this embodiment, the prior-to-change source code and the after-change source code are assumed to have been stored in the storage unit 4 in advance. The acquiring unit 11 may acquire the prior-to-change source code and the after-change source code from another computer or the like via a network or the like.

The analyzing unit 12 performs static analysis on the prior-to-change source code and the after-change source code. Static analysis in this embodiment is assumed to include analysis of character strings of the source code, and analysis of the syntax (structure) of the analyzed character strings. The analyzing unit 12 is an example of an identifying unit.

Based on the results of the static analysis, the analyzing unit 12 identifies logic operations that have changed from the prior-to-change source code (hereafter, referred to as changed logic operations) from out of the source code included in the after-change source code. Such a logic operation is an example of processing content. In addition, a changed logic operation is an example of changed processing content.

The test-executing unit 13 executes the after-change source code using a plurality of parameters. In order to test the source code, it is preferable that the plurality of parameters used by the test-executing unit 13 include a parameter with which the after-change source code operates normally and a parameter with which the source code does not operate normally. Such a parameter is a test parameter and is an example of a test.

When executing the after-change source code for each of the plurality of parameters, the test-executing unit 13 identifies an executed changed logic operation out of a plurality of changed logic operations included in the after-change source code. In this way, the path of a changed logic operation that is followed when the after-change source code is executed is identified for each of the parameters.

The test-executing unit 13 associates each of the plurality of parameters with an identified changed logic operation. In addition, the test results of the prior-to-change source code, the test results of the after-change source code, and the plurality of parameters are associated with one another by the analyzing unit 12.

Therefore, the plurality of parameters are associated with the test results of the prior-to-change source code, the test results of the after-change source code, and the identified changed logic operations. A correspondence relationship table that illustrates the correspondence relationships between the parameters, the test results of the prior-to-change source code, the test results of the after-change source code, and the identified changed logic operations is stored in the storage unit 4.

The grouping unit 14 refers to the correspondence relationship table and groups the parameters based on the changed logic operations and differences between the test results for the individual parameters.

The grouping unit 14 groups together parameters such that parameters for which a changed logic operation is the same and for which the difference between the test results is the same belong to one group. The grouping unit 14 groups together parameters such that parameters for which a changed logic operation is the same and for which there is no difference between the test results belong to one group.

Testing of the after-change source code is performed through visual inspection carried by a verifier who performs verification of the testing. A plurality of parameters are used in the tests of the after-change source code. It is assumed that tests of a plurality of parameters belonging to the same group have the same test pattern. Therefore, for a plurality of parameters belonging to the same group, it is sufficient to perform a test in which one parameter among the plurality of parameters is used.

Therefore, the number of parameters used when testing the after-change source code is reduced, and consequently the testing work becomes more efficient and support is given to the testing work.

The grouping unit 14 takes the number of parameters belonging to a group as a similarity number and sets the highest priority for the group having the smallest similarity number. The grouping unit 14 sets the priorities of the plurality of groups in descending order from the group having the smallest similarity number. Therefore, the group with the highest similarity number has the lowest priority.

“Priority” indicates the degree of priority for verification of the source code by visual inspection. “Similarity number” is an example of a test number. “Priority” may also refer to a checking priority. “Checking priority” is an example of priority information.

The output unit 15 adds the priorities to the correspondence relationship table obtained through the grouping performed by the grouping unit 14, and outputs the correspondence relationship table to the display unit 3. Therefore, the correspondence relationship table is displayed on the display unit 3. As described above, the correspondence relationship table is a correspondence relationship table in which the number of parameters is reduced by grouping the parameters together.

The output unit 15 may output a correspondence relationship table that exists prior to performance of grouping to the display unit 3. The correspondence relationship table itself may be displayed on the display unit 3, or information obtained by performing prescribed processing on the correspondence relationship table may be displayed on the display unit 3.

For example, the display unit 3 may set a certain region of the screen to be a fixed window, and may display the correspondence relationship table in the fixed window. The display unit 3 may display the after-change source code in another region of the screen.

The display content of after-change source code displayed in the other region changes with a scrolling operation for example, whereas the display of the correspondence relationship table does not change. Therefore, the verifier is able to easily verify the after-change source code.

Examples of Source Code

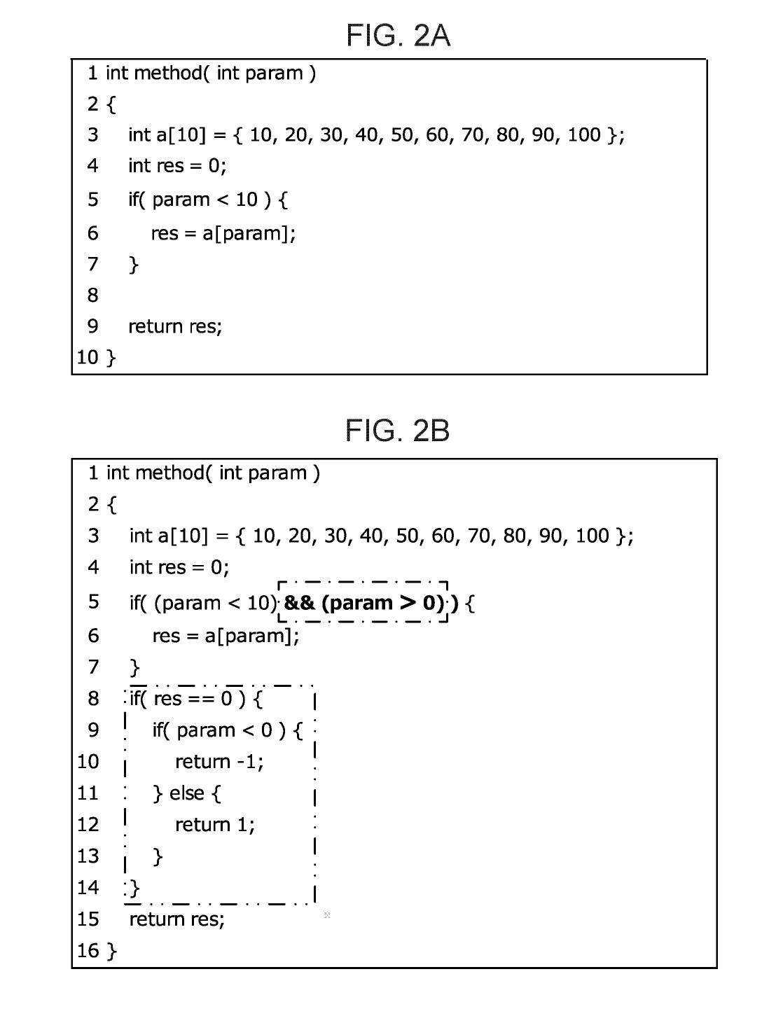

FIG. 2A illustrates an example of prior-to-change source code, and FIG. 2B illustrates an example of after-change source code.

The rectangular portion indicated by a one-dot chain line in the fifth line of the after-change source code in FIG. 2B indicates a condition that has been newly added. In the prior-to-change source code in the example in FIG. 2A, the instruction in the sixth line is executed when the condition “param<10” in the fifth line is satisfied.

In contrast, in the after-change source code, the instruction in the sixth line is executed when both the condition “param<10” and the condition “param>0” are satisfied.

The rectangular portion indicated by a two-dot chain line (from instruction in eighth line to instruction in fourteenth line) indicates instructions added to the prior-to-change source code. In the after-change source code, a value “−1” or “1” is returned when the condition “res==0” is satisfied.

Changes made to source code in this embodiment may include not only adding of a condition or an instruction, but also rewriting, deletion and so on of a condition or an instruction. The prior-to-change source code and the after-change source code are stored in the storage unit 4. The acquiring unit 11 acquires the prior-to-change source code and the after-change source code from the storage unit 4.

Example of Correspondence Relationship Table

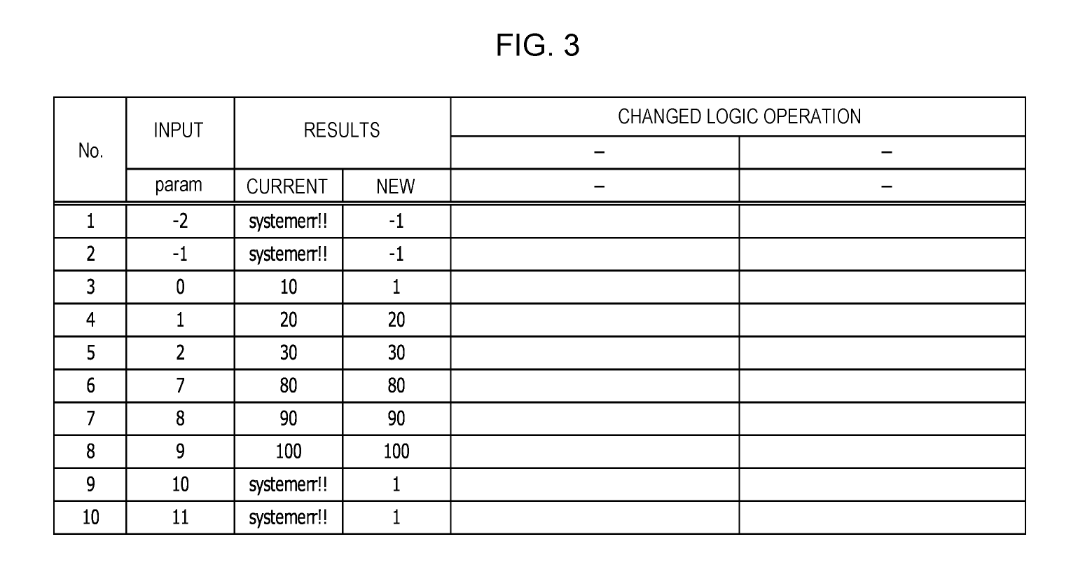

FIG. 3 is illustrates an example of a correspondence relationship table. The correspondence relationship table includes the items: number, input, results, and changed logic operation. The correspondence relationship table is an example of information representing a correspondence relationship. “Number” indicates the number of a parameter. In the example in FIG. 3, number is depicted as “No.”.

In addition, “input” indicates a parameter (“param” in FIG. 3). The parameter indicates a value that is used when the test-executing unit 13 executes the after-change source code. In the example in FIG. 3, ten parameters are recorded in the correspondence relationship table. The number of parameters may be an arbitrary number.

“Results” indicates test results of the prior-to-change source code and test results of the after-change source code. “Current” in the results indicates the test results of the prior-to-change source code. “New” in the results indicates the test results of the after-change source code.

As described above, “changed logic operation” is a logic operation that has changed from the prior-to-change source code out of the source code included in the after-change source code. A plurality of changed logic operations are included in the after-change source code. The number of changed logic operations in the correspondence relationship table corresponds to the number of changed logic operations identified by the analysis unit 12.

In the case where the value of the parameter “param” in the sixth line of the prior-to-change source code in the example in FIG. 2A is less than “0”, the execution result of the prior-to-change source code is a system error. The system error is illustrated as “systemerr!!” in the example in FIG. 3.

In addition, there are cases where the test result of the prior-to-change source code and the test result of the after-change source code are the same and cases where the test results are different. Furthermore, in the case where the test results are different, there are cases where the differences between the test results are different.

In the example in FIG. 3, for example, in the case where the parameter is “2”, the test result of the prior-to-change source code and the test result of the after-change source code are the same.

On the other hand, in the case where the parameter is “−1”, the test result of the prior-to-change source code and the test result of the after-change source code are different. Furthermore, in the case where the parameter is “0”, the test result of the prior-to-change source code and the test result of the after-change source code are different. The differences between the test results for when the parameter is “−1” and the test results for when the parameter is “0” (differences between test results of prior-to-change source code and test results of after-change source code) are different.

Example of Identification of Changed Logic Operation

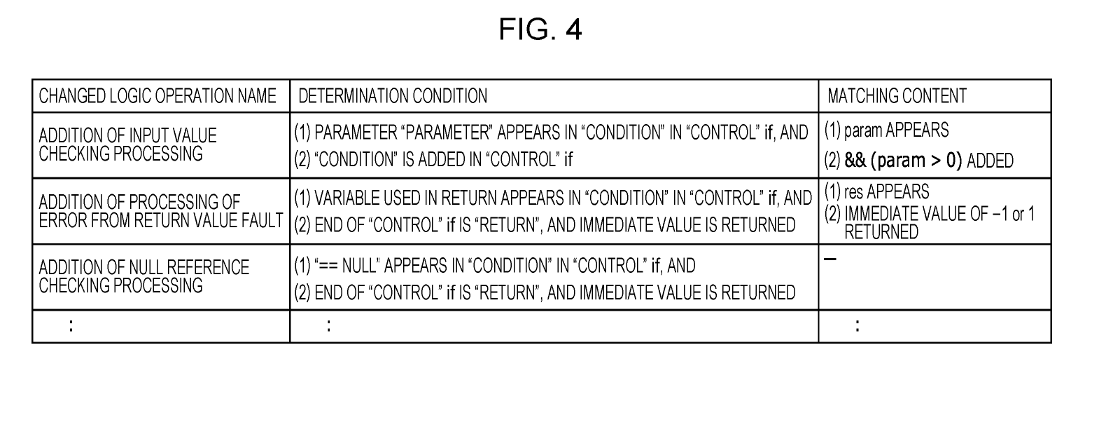

An example of identification of a changed logic operation will be described. The analyzing unit 12 identifies a changed logic operation that has changed from the prior-to-change source code from among the logic operations included in the after-change source code by using a determination table illustrated in the example in FIG. 4. The determination table is stored in the storage unit 4, for example.

As illustrated in the example in FIG. 4, the determination table includes the items: changed logic operation name, determination condition, and matching content. In the example in FIG. 4, three examples of changed logic operation determination conditions included in the determination table are illustrated, but the number of changed logic operation determination conditions included in the determination table may be a number other than three.

“Changed logic operation name” indicates the name of a changed logic operation. “Determination condition” indicates a condition for identifying a changed logic operation from the prior-to-change source code and the after-change source code. The determination condition may include a plurality of conditions. “Matching content” indicates information regarding matching content when a changed logic operation is identified based on a determination condition.

The analyzing unit 12 in this embodiment identifies a changed logic operation using the determination table. The analyzing unit 12 performs static analysis on the prior-to-change source code and the after-change source code, and identifies a changed logic operation based on analysis results (analysis data) and the determination table.

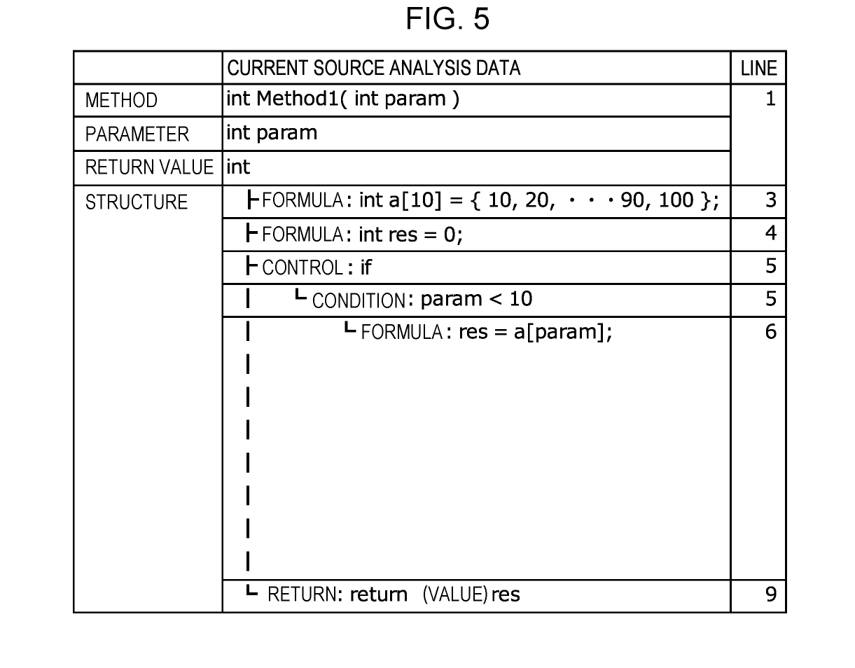

FIG. 5 illustrates an example of results (analysis data) obtained as a result of the analyzing unit 12 performing static analysis on the prior-to-change source code. In the example in FIG. 5, “current source analysis data” indicates analysis data for the prior-to-change source code.

In the example in FIG. 5, “line” indicates the line of an instruction in the example of the prior-to-change source code in FIG. 2A. For example, the analyzing unit 12 performs static analysis on the prior-to-change source code by performing analysis of character strings and analyzing the structure of the prior-to-change source code based on analysis results of the character strings. The static analysis may be analysis in which techniques other than analysis of character strings and analysis of structure (syntax) are used.

The analysis data illustrated in the example in FIG. 5 is obtained as a result of the analyzing unit 12 performing static analysis on the prior-to-change source code. The analysis data indicates the structure, function (method), value and so on of each instruction in the prior-to-change source code.

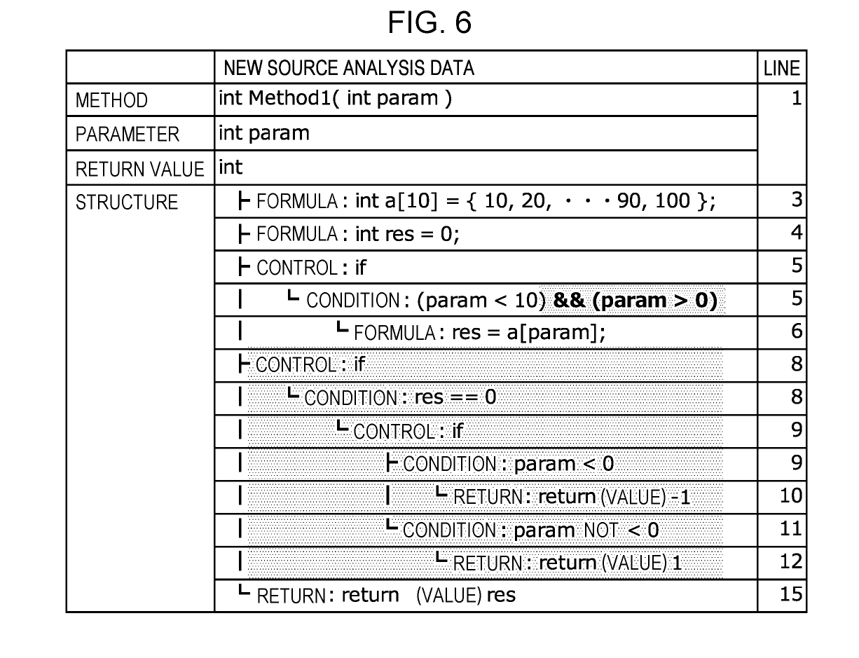

FIG. 6 illustrates an example of results (analysis data) obtained as a result of the analyzing unit 12 performing static analysis on the after-change source code. In the example in FIG. 6, “new source analysis data” indicates analysis data of the after-change source code.

In the example in FIG. 6, the shaded rectangular portions indicate changed logic operations that have changed from the prior-to-change source code. For example, a new condition has been added to the condition illustrated in the fifth line illustrated in the structure.

In the prior-to-change source code, the condition is “param<10”, whereas in the after-change source code, the condition has been changed to a condition of “param<10” and “param>0” being satisfied.

In addition, the analysis data of the after-change source code illustrated in the example in FIG. 6 indicates that instructions from the eighth line to the fourteenth line have been added in the after-change source code. The analyzing unit 12 compares the analysis data of the prior-to-change source code and the analysis data of the after-change source code, and identifies changed parts.

In the case of the example in FIG. 6, the analyzing unit 12 identifies that the fifth line and the eighth to fourteenth lines contain changed logic operations. At this time, the instructions from the eighth line to the fourteenth line belong to “control:if”, and therefore the analyzing unit 12 identifies the instructions from eighth line to the fourteenth line together as one changed logic operation.

The analyzing unit 12 refers to the determination table stored in the storage unit 4, and determines whether the identified changed logic operation matches a determination condition in the determination table. The changed part in the fifth line is a condition of “control:if”, and this matches the first condition among the determination conditions corresponding to “addition of input checking processing” in the determination table in FIG. 4.

In addition, since a condition of “control:if” is added in the changed part of the fifth line, this matches the second condition among the determination conditions corresponding to “addition of input checking processing” in the determination table in FIG. 4. Therefore, the analyzing unit 12 identifies that a logic operation corresponding to the fifth line of the after-change source code is a changed logic operation.

The analyzing unit 12 adds an item indicating matching content in the changed part of the fifth line to the changed logic operation in the correspondence relationship table. Furthermore, the analyzing unit 12 adds information indicating the content of the changed logic operation to the matching content item in the determination table.

In the changed logic operation from the eighth line to the fourteenth line, the eighth line includes a condition of “control:if”, and the fourteenth line, which is the last (final) line, indicates that there is a return and a value “1” is returned. Therefore, the changed logic operation from the eighth line to the fourteenth line satisfies determination conditions corresponding to “addition of processing of error due to fault at time of return operation” in the determination table.

The analyzing unit 12 adds an item indicating matching content in the changed part in the eighth to fourteenth lines to the changed logic operation in the correspondence relationship table. Furthermore, the analyzing unit 12 adds information indicating the content of the changed logic operation to the matching content item in the determination table.

As described above, the analyzing unit 12 performs static analysis on the prior-to-change source code and the after-change source code, and identifies a changed logic operation. The analyzing unit 12 may instead identify a changed logic operation without performing static analysis.

For example, the analyzing unit 12 may instead identify a changed logic operation based on analysis results character strings of the prior-to-change source code and the after-change source code and comparison of the analysis results. On the other hand, a changed logic operation is sometimes not identified using just analysis of character strings.

Therefore, although a case is described in which the analyzing unit 12 performs static analysis on the prior-to-change source code and the after-change source code in this embodiment, a changed logic operation may be identified based on analysis of character strings.

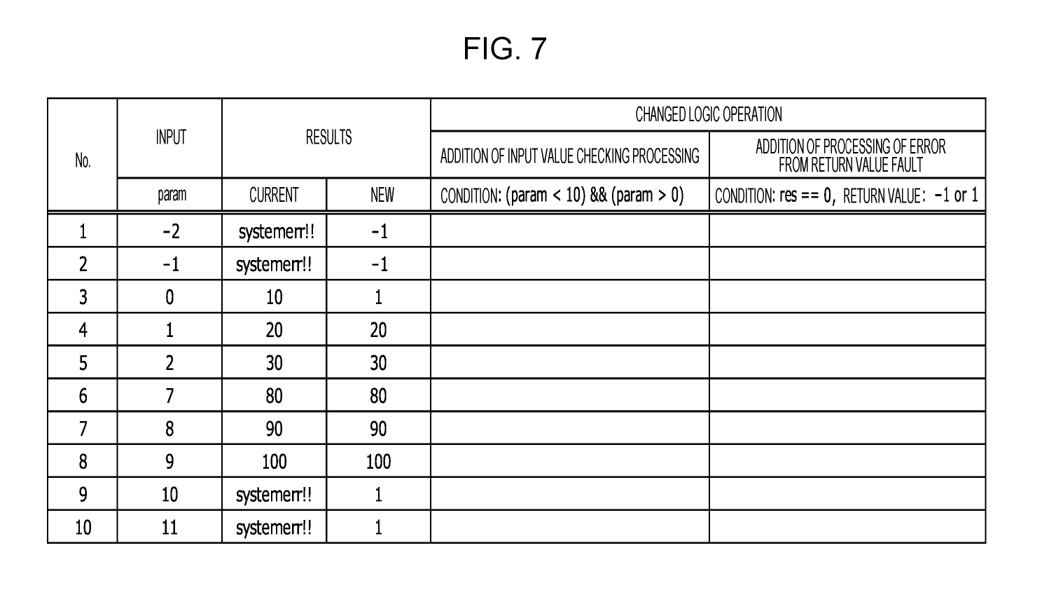

As described above, the analyzing unit 12 adds the above-described two changed logic operation items to the correspondence relationship table. FIG. 7 illustrates an example in which the two changed logic operations have been added to the correspondence relationship table.

The above-mentioned “addition of input checking processing” and “addition of processing of error from fault at time of return” are added to the changed logic operation item in the correspondence relationship table. The analyzing unit 12 adds information corresponding to the two changed logic operations to the correspondence relationship table.

Example of Acquisition of Execution Path

As illustrated in the example in FIG. 7, ten parameters are included in the correspondence relationship table. The test-executing unit 13 of the information processing device 1 tests the after-change source code by executing the after-change source code using the ten parameters.

The test-executing unit 13 performs testing by executing the after-change source code using each parameter. Execution of the after-change source code may also be referred to as symbolic execution. The test-executing unit 13 acquires an execution path of the after-change source code for each test using a corresponding parameter.

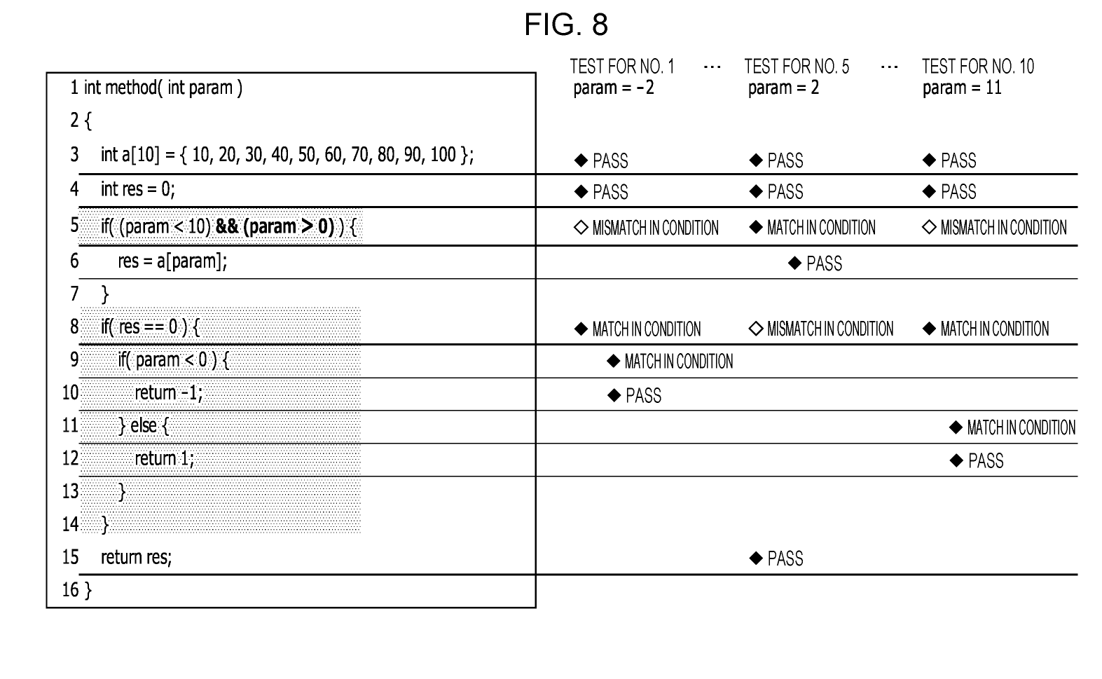

As illustrated in the example in FIG. 8, in the case of the test in which “−2” is used in the parameter “param”, there is a mismatch in an “if” condition in the fifth line of the after-change source code. Therefore, the changed logic operation in the fifth line is not executed (is not passed) in the test using this parameter.

On the other hand, the value of “res” is set to “0” in the fourth line. Therefore, in the test in which “−2” is used in the parameter “param”, there is a match in the condition in the eighth line, and therefore the one changed logic operation from the eighth line to the fourteenth line is executed.

In the changed logic operation from the eighth line to the fourteenth line, a return value (return) becomes “−1” or “1” based on the value of the parameter “param”. In the test in which “−2” is used in the parameter “param”, the condition “param<0” is satisfied, and therefore the return value becomes “−1”.

In the case of the test in which “2” is used in the parameter “param”, there is a match in the conditions of “if” in the fifth line of the after-change source code. Therefore, the changed logic operation of the fifth line is executed. In this case, the instruction of the sixth line is executed.

The value of a[param] is substituted into value “res” in the instruction of the sixth line. The value of “param” is “2”, and a value “10” is substituted into a [2] in the third line. Therefore, the value “res” is “10”. Since the value “res” is “10”, there is not a match in the condition of the eighth line. Therefore, the changed logic operation from the eighth line to the fourteenth line is not executed.

In the case of the test in which “11” is used in the parameter “param”, as illustrated in the example in FIG. 8, the changed logic operation of the fifth line is not executed, but the changed logic operation from the eighth line to the fourteenth line is executed.

As described above, the test-executing unit 13 executes the after-change source code for each test using a corresponding parameter, and acquires the execution paths of the changed logic operations. When executing a test using a parameter for each of the parameters, the test-executing unit 13 records the executed changed logic operations in the correspondence relationship table.

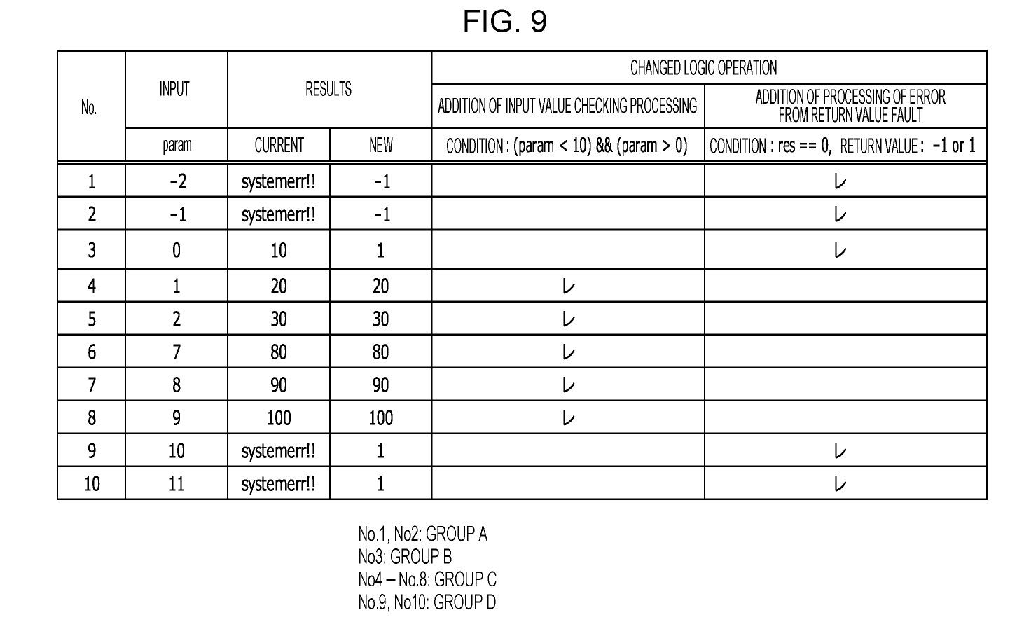

As described above, the test-executing unit 13 acquires the paths of the executed changed logic operations for each of the parameters. The test-executing unit 13 records information indicating the execution in the changed logic operation item for each of the parameters. In the example in FIG. 9, check marks are recorded in the executed changed logic operation items.

In the example in FIG. 9, the correspondence relationship table indicates that the changed logic operation “addition of processing of error from return value fault” was executed in the tests using the parameters corresponding to numbers 1-3 and 9-10.

In addition, the correspondence relationship table indicates that the changed logic operation “addition of input value checking processing” was executed in the tests using the parameters corresponding to numbers 4-8.

The parameters in the correspondence relationship table in the example in FIG. 9 may be sorted into a plurality of groups. The groups are obtained by sorting the parameters based on differences between test results and changed logic operations. The parameters are sorted into a group in which the test result difference is the same and into a group in which there is no test result difference for each changed logic operation.

In the case of the example in FIG. 9, the changed logic operation is “addition of processing of error from return value fault” for the parameters corresponding to numbers 1 to 3 and numbers 9 to 10. The test result difference is the same for the parameters corresponding to numbers 1 and 2. Therefore, the parameters corresponding to numbers 1 and 2 are sorted into the same group.

There is a test result difference for the parameter corresponding to number 3, but the test result difference is different from that for numbers 1 and 2. Therefore, the parameter corresponding to number 3 is sorted into a different group from the group containing the parameters corresponding to numbers 1 and 2.

There is a test result difference for the parameters corresponding to numbers 9 and 10, and the parameters are sorted into a group that is different from the group containing the parameters corresponding to numbers 1 and 2 and the group containing the parameter corresponding to number 3.

The changed logic operation is “addition of input value checking processing” for the parameters corresponding to numbers 4 to 8. The test result difference is the same for the parameters corresponding to numbers 4 to 8. Therefore, the parameters corresponding to numbers 4 to 8 are sorted into the same group.

For example, the output unit 15 may output the correspondence relationship table illustrated in the example in FIG. 9 to the display unit 3. The correspondence relationship table is displayed on the display unit 3, and the correspondence relationship table is thus presented to the verifier operating the information processing device 1.

The same changed logic operation is executed and the test result difference is the same for parameters belonging to the same group. Therefore, in the case of a plurality of parameters belonging to one group, it is assumed that the tests using the plurality of parameters will follow paths having the same pattern.

For example, in tests using the plurality of parameters belonging the group containing numbers 4 to 8, it is assumed that the same path is followed in the after-change source code. As described above, verification of the after-change source code is performed through visual inspection carried out by a verifier, for example. This verification is included in the testing work.

Verification for a plurality of parameters that follow paths of the same pattern may be realized by performing verification for one parameter out of the plurality of parameters.

For example, in order to verify the five parameters belonging to the group containing numbers 4 to 8, it is sufficient to just verify one parameter among the five parameters. This is because it is assumed that the path of the changed logic operation for the one parameter and the paths of the changed logic operation for the other four parameters are the same.

The verifier verifies the one parameter among the five parameters based on the correspondence relationship table displayed on the display unit 3. Therefore, since the number of parameters that are to be verified has been reduced, the testing work is more efficient.

The output unit 15 may cause information indicating the relationship between the numbers or the parameters and the groups to be displayed on the display unit 3. For example, the output unit 15 may cause information regarding the groups A to D illustrated in the example in FIG. 9 to be displayed on the display unit 3.

Example of Grouping Processing

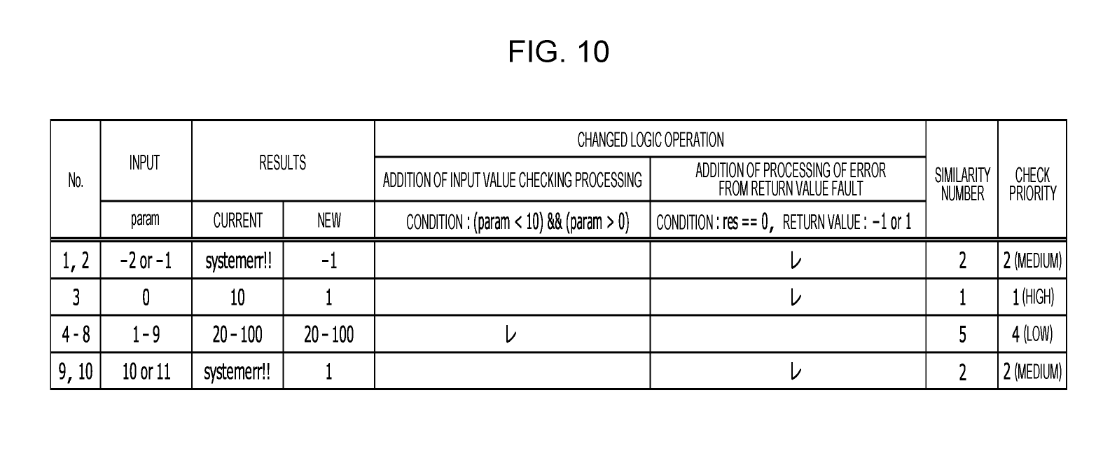

Next, grouping processing will be described. The grouping unit 14 performs processing that is the same as the sorting described above based on the correspondence relationship table, and generates a grouping table such as that illustrated in the example in FIG. 10. The grouping table is one example of information indicating the correspondence relationships for a plurality of grouped tests.

The grouping unit 14 performs grouping by referring to the correspondence relationship table and sorting a plurality of parameters corresponding to the same changed logic operation into a group for which the test result difference is the same and a group for which there is no test result difference.

The grouping unit 14 performs grouping such that the parameters corresponding to numbers 1 and 2 belong to one group. Regarding the parameter corresponding to number 3, there is no other parameter having the same changed logic operation and the same test result difference, and therefore the grouping unit 14 allocates the parameter corresponding to number 3 to one group.

The grouping unit 14 performs grouping such that the parameters corresponding to numbers 4 to 8 belong to one group. The grouping unit 14 performs grouping such that the parameters corresponding to numbers 9 and 10 belong to one group.

The grouping unit 14 generates a grouping table illustrating the results obtained by grouping the parameters of the correspondence relationship table. Since a plurality of parameters are grouped so as to belong to one group in the grouping table, the amount of information (number of parameters to be verified) in the grouping table is reduced compared with the correspondence relationship table.

The grouping unit 14 counts the number of parameters belonging to each group as a similarity number. In the grouping table, each similarity number corresponds to one or a plurality of numbers indicating a group. The grouping unit 14 adds the item “similarity number” to the grouping table.

Furthermore, the grouping unit 14 adds an item “check priority” to the grouping table. “Check priority” indicates the priority with respect to verification by visual inspection. A parameter belonging to a group having high priority (check priority) indicates that the importance of verifying the parameter through visual inspection is higher than for a parameter belonging to a group having low priority.

Based on the similarity numbers of the groups, the grouping unit 14 adds higher priorities to groups having smaller similarity numbers. Therefore, the grouping unit 14 adds the highest priority to the group having the smallest similarity number, and adds the lowest priority to the group having the largest similarity number. In the example in FIG. 10, an example is illustrated in which there are three levels of priority, but there may instead be two or four or more levels of priority.

For example, in a test using parameter “0” corresponding to number 3, there is no other parameter for which the same changed logic operation is executed and for which the test result difference is the same.

In other words, the uniqueness of the parameter “0” corresponding to number 3 is high. Therefore, there is a high probability that a fault may occur in a part corresponding to parameter “0” belonging the group having the smallest similarity number in the after-change source code. Such a fault is referred to as degradation or a bug, for example.

On the other hand, the grouping table illustrates that, in the tests in which the parameters corresponding to numbers 4 to 8 were used, the same changed logic operation is executed and there are a plurality of parameters for which there is no test result difference. Therefore, the uniqueness of these parameters is low and there is a low probability of a fault occurring in parts corresponding to these parameters.

Therefore, based on the similarity numbers of the groups, the grouping unit 14 adds higher priorities to groups having smaller similarity numbers. The output unit 15 outputs the grouping table including the items similarity number and check priority to the display unit 3. The display unit 3 displays the grouping table.

The verifier operating the information processing device 1 performs verification by carrying out visual inspection based on the grouping table displayed on the display unit 3. In the grouping table, the number of parameters to be verified has been reduced from ten to four via the processing performed by the grouping unit 14.

Therefore, the testing work is more efficient when the verifier verifies the after-change source code due to the number of parameters to be verified having been reduced.

In addition, the grouping table includes the item “check priority”. The verifier may verify the after-change source code sequentially from the parameter having the highest check priority. Since it is assumed that a parameter having a high check priority has high uniqueness, there is a high probability of the verifier being able to quickly find a part where a fault occurs.

In the example of the after-change source code in FIG. 2B, “&&param>0” has been added to the condition of “if” in the fifth line, but the after-change source code would be correct source code if the added condition were “&&param>=0”. In other words, “&&param>0” is a fault in the after-change source code.

Therefore, the verifier may verify a fault included in the after-change source code when verifying the after-change source code through visual inspection using the parameter “0”. As described above, since the verifier may verify with priority the parameter “0” by carrying out visual inspection, the verifier may quickly find the fault included in the after-change source code.

The output unit 15 may output to the display unit 3 a grouping table to which the similarity number has been added but to which the check priority has not been added. In this case, a grouping table to which the similarity number has been added is displayed on the display unit 3.

The verifier may perform verification in order of priority from parameter(s) belonging to a group having a small similarity number based on the grouping table displayed on the display unit 3.

In addition, the output unit 15 may output to the display unit 3 a grouping table to which the check priority has been added but to which the similarity number has not been added. In this case, a grouping table to which the check priority has been added is displayed on the display unit 3.

The verifier may perform verification in order of priority from parameter(s) belonging to a group having a high check priority based on the grouping table displayed on the display unit 3.

Modification 1

Next, modification 1 will be described. Modification 1 is an example in which a grouping table is output in the case where a fault has occurred in a part of the prior-to-change source code other than a part that has changed.

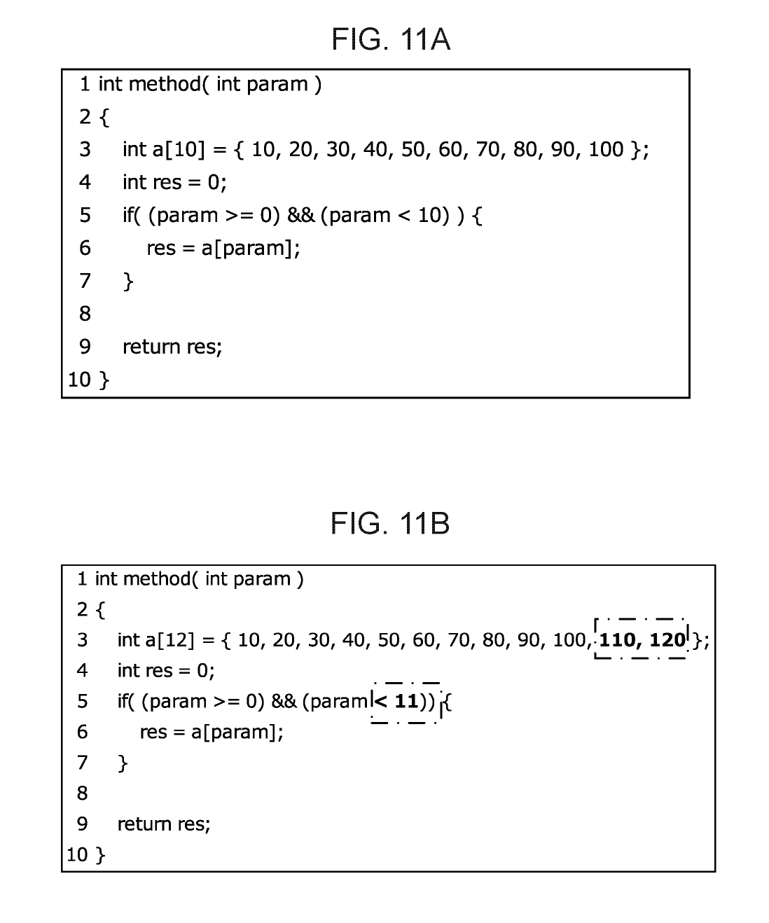

FIG. 11A illustrates an example of prior-to-change source code of modification 1, and FIG. 11B illustrates an example of after-change source code of modification 1. The rectangular parts surrounded by one-dot chain lines in FIG. 11B are changed parts.

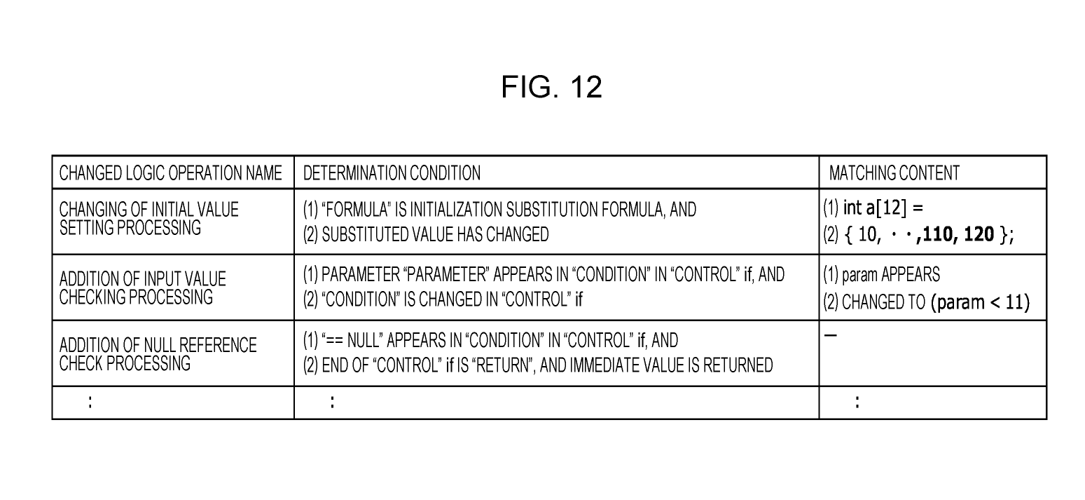

FIG. 12 illustrates an example of a determination table of modification 1. The determination table is different from the determination table of the above-described embodiment (determination table in FIG. 4). The determination table of modification 1 includes determination conditions “changing of initial value setting processing” and “addition of input value checking processing”. The determination table is stored in the storage unit 4.

For example, the determination conditions “changing of initial value setting processing” and “addition of input value checking processing” may be added to the determination table of modification 1 in the items of the determination table of the embodiment (determination table in FIG. 4).

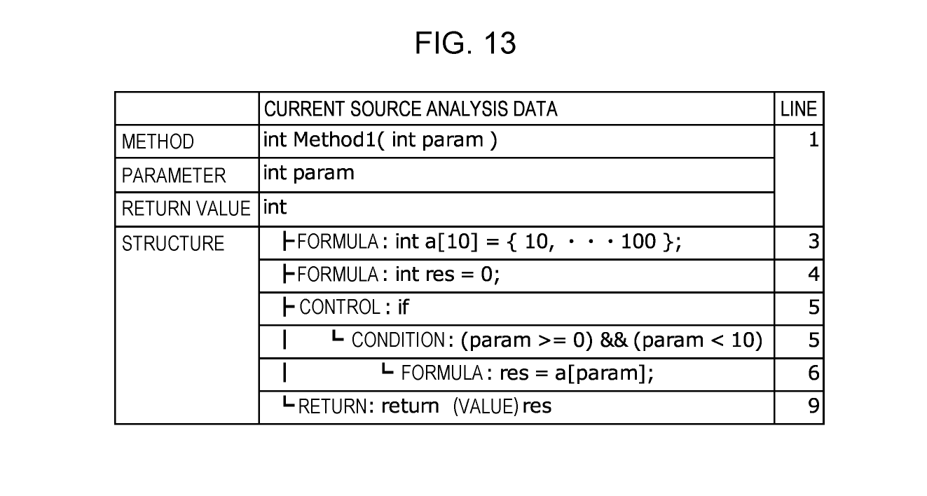

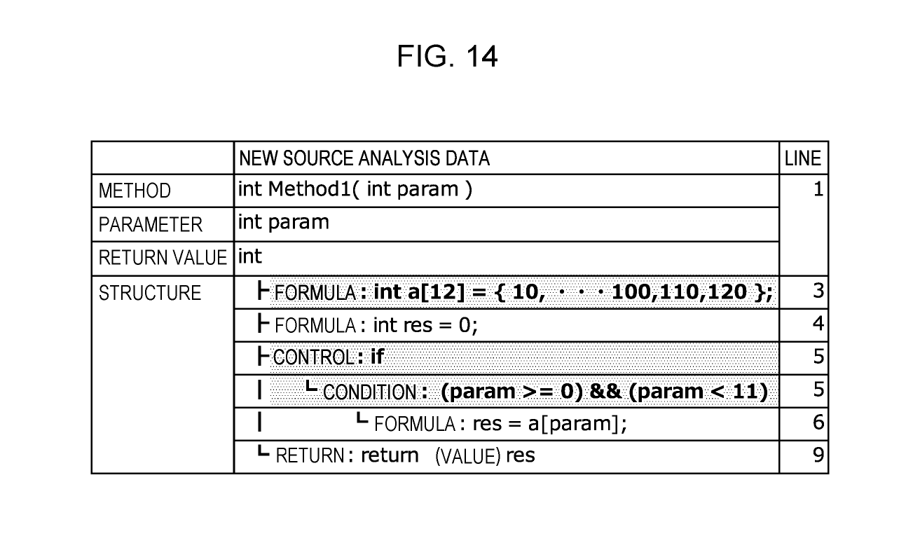

The analyzing unit 12 performs static analysis on the prior-to-change source code and the after-change source code. FIG. 13 illustrates an example of analysis data of the prior-to-change source code in modification 1. FIG. 14 illustrates an example of analysis data of the after-change source code in modification 1. The shaded rectangular portions indicate logic operations that have changed from the prior-to-change source code in the analysis data of the after-change source code in the example in FIG. 14.

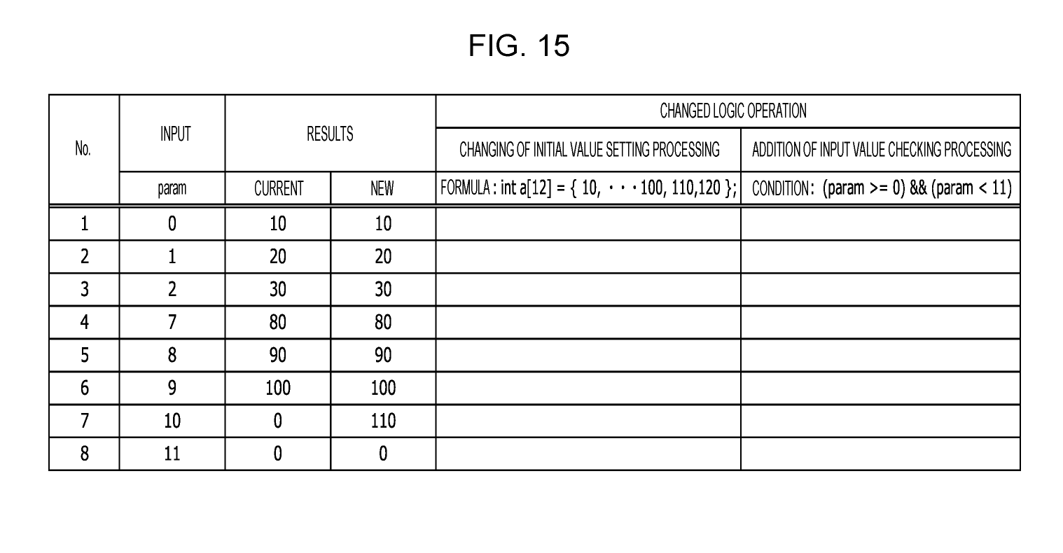

As illustrated in the example in FIG. 15, the analyzing unit 12 adds “changing of initial value setting processing” and “addition of input value checking processing” to the changed logic operation items.

The test-executing unit 13 executes testing of the after-change source code using the parameters included in the correspondence relationship table. Execution of testing of the after-change source code is an example of symbolic execution.

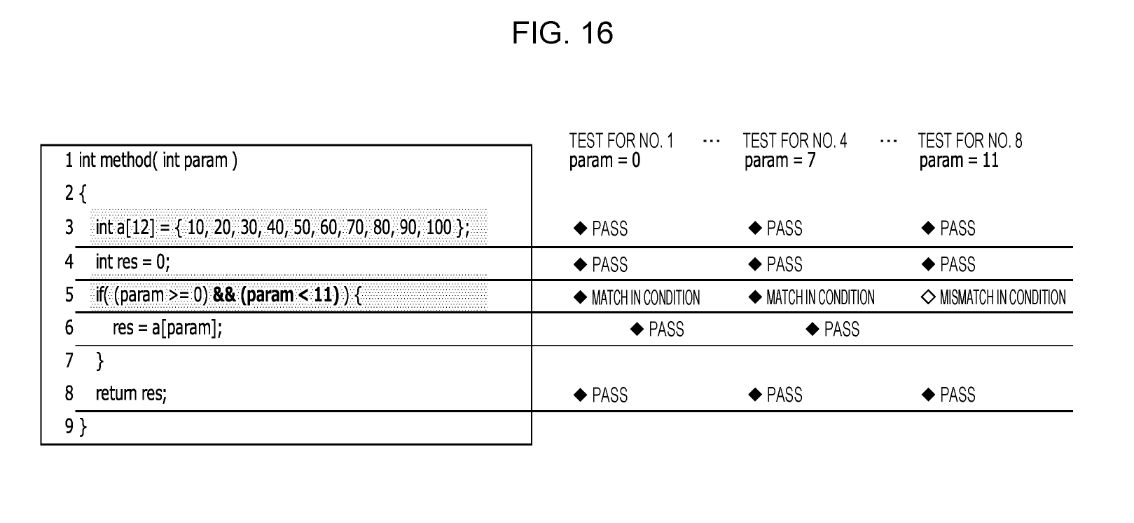

FIG. 16 illustrates examples of the paths of the changed logic operations when the test-executing unit 13 executes the after-change source code for each of the parameters. The test-executing unit 13 acquires the paths of the changed logic operations.

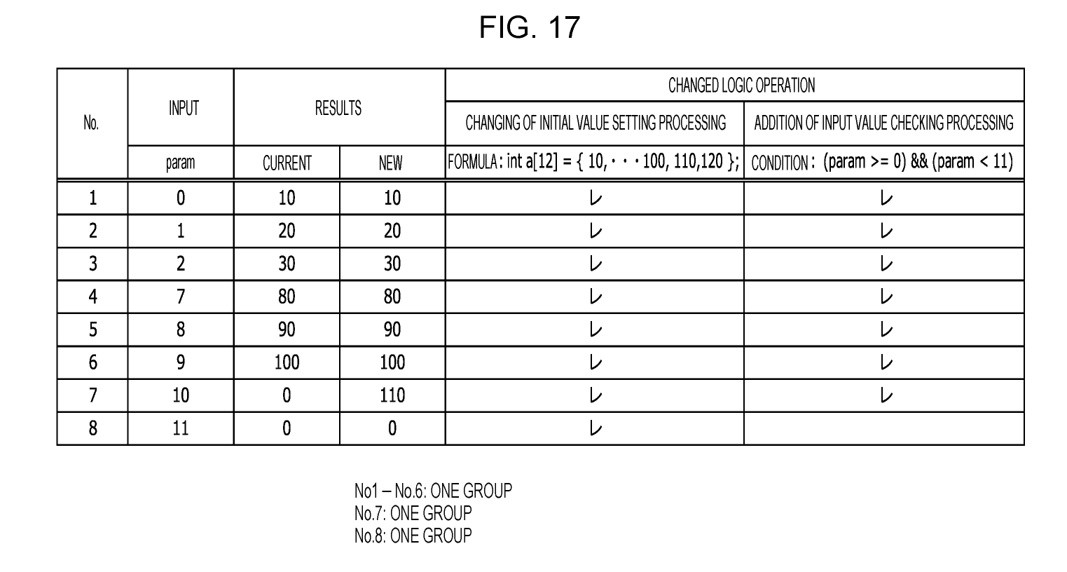

FIG. 17 illustrates an example of a correspondence relationship table based on execution results generated by the test-executing unit 13. The output unit 15 may output the correspondence relationship table to the display unit 3.

As illustrated in the example of the correspondence relationship table in FIG. 17, numbers 1 to 6 correspond to the same changed logic operations and the test result differences are the same. Therefore, the grouping unit 14 performs grouping such that the parameters corresponding to numbers 1 to 6 belong to one group.

There is no other parameter that follows the same changed logic operation and has the same test result difference as the parameter “10” of number 7. Therefore, the grouping unit 14 allocates the parameter “10” of number 7 to one group.

There is no other parameter that follows the same changed logic operation as the parameter “11” of number 8 and for which there is no test result difference. Therefore, the grouping unit 14 allocates the parameter “11” of number 8 to one group.

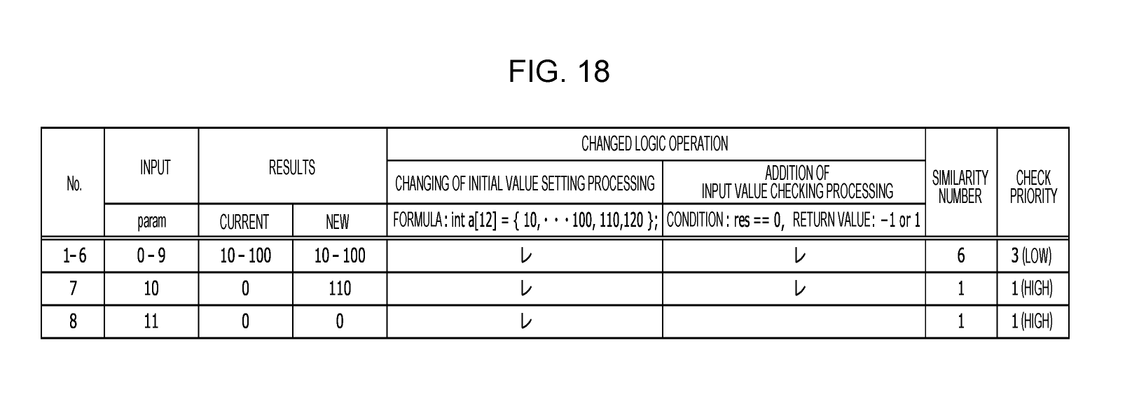

FIG. 18 illustrates an example of a grouping table generated by the grouping unit 14 performing grouping with respect to the correspondence relationship table. As illustrated in the example in FIG. 18, the number of parameters that are to be verified has been reduced, and therefore the testing work is more efficient.

In the example in FIG. 18, the similarity number corresponding to number 7 (parameter “10”) and the similarity number corresponding to number 8 (parameter “11”) are the same. Therefore the respective check priorities are the same.

The verifier verifies the after-change source code illustrated in the example in FIG. 11B by carrying out visual inspection using either of the two parameters having the same check priority. For example, it is assumed that the verifier verifies the after-change source code by carrying out visual inspection using the parameter “10”. In this case, no faults are found in the after-change source code.

Next, it is assumed that the verifier verifies the after-change source code through visual inspection using the parameter “11”. In this case, the parameter “11” does not match a condition of “if” in the fifth line, and therefore it is found that an instruction of substituting a[param] into value “res” is not executed.

Therefore, it is verified that the changed part “<11” in the fifth line of the after-change source code is a fault and a changed part “<=11” would be correct.

As described above, there is no test result difference for the parameter “11”. Even in the case where there is no test result difference, a fault may be found in the source code based on the grouping table of modification 1. In modification 1 as well, the number of parameters that are to be verified has been reduced, and therefore the testing work is more efficient.

Modification 2

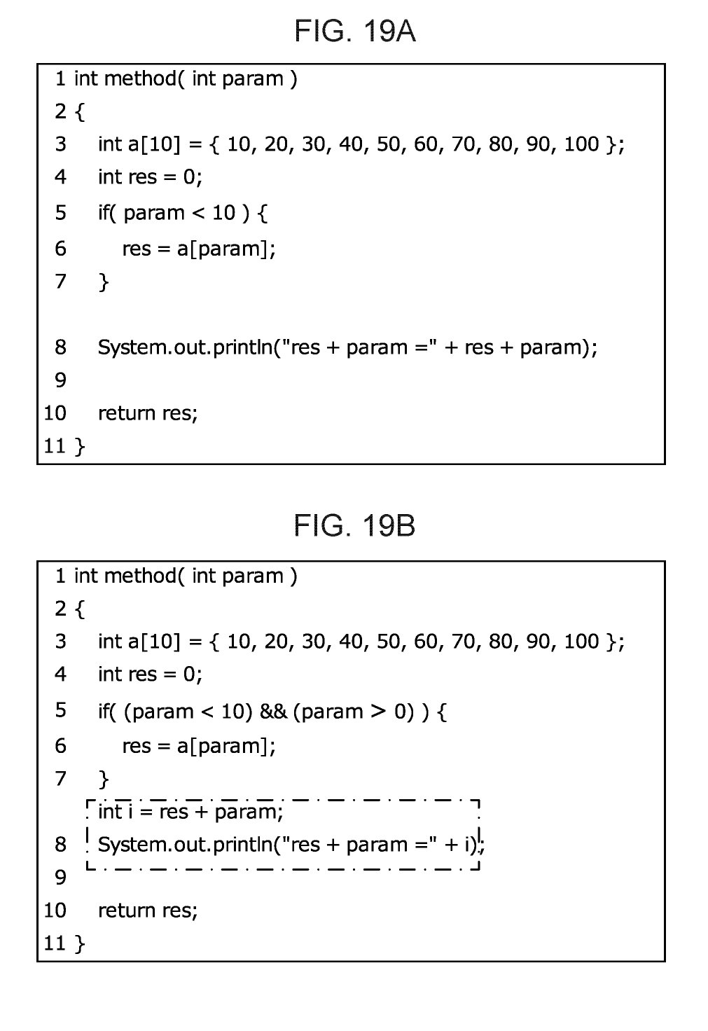

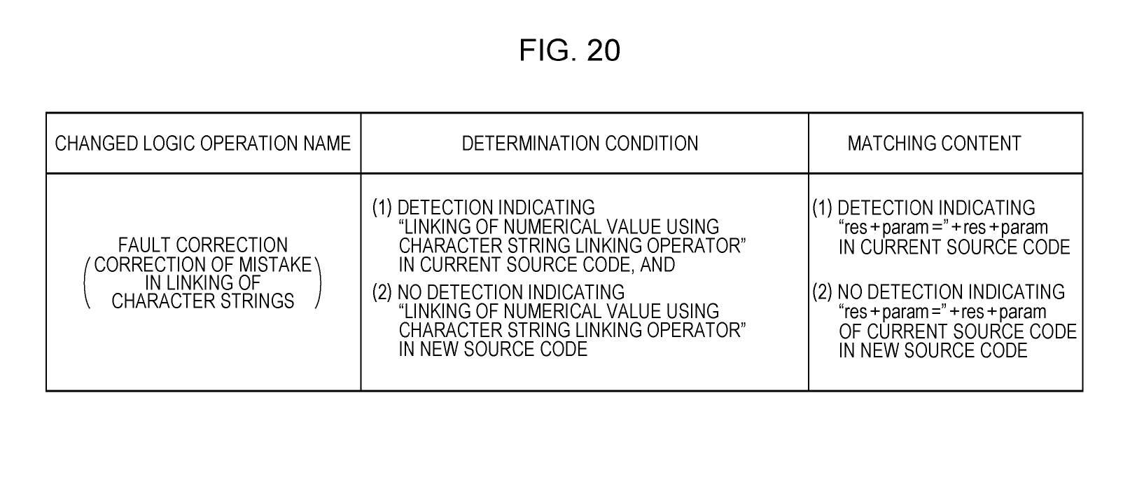

Modification 2 is an example in which it is identified that a logic operation in the after-change source code that has changed from the prior-to-change source code is an intentional correction. FIG. 19A illustrates an example of prior-to-change source code of modification 2, and FIG. 19B illustrates an example of after-change source code of modification 2. In addition, FIG. 20 illustrates an example of a determination table of modification 2.

In the prior-to-change source code in FIG. 19A and the after-change source code in FIG. 19B, the description corresponding to the eighth line satisfies a determination condition in the determination table in the example in FIG. 20.

“Linking of numerical value using character string linking operator” among the determination conditions in the determination table in the example in FIG. 20 indicates a fault in the source code (for example, violation of description rule). In addition, the determination conditions in the determination table in FIG. 20 indicate determination conditions for detecting a logic operation in which the fault is included in the prior-to-change source code and the fault is not included in the after-change source code.

The analyzing unit 12 performs static analysis on the prior-to-change source code and the after-change source code, and determines that the prior-to-change source code in FIG. 19A and the after-change source code in FIG. 19B satisfy the determination conditions in the example in FIG. 20.

In other words, the analyzing unit 12 determines that a logic operation that includes the fault (abnormal logic operation) is included in the prior-to-change source code, and that the fault has been resolved in the after-change source code.

The analyzing unit 12 adds “fault correction (correction of mistake in linking of character strings)” to changed logic operation items in the correspondence relationship table. The output unit 15 outputs the correspondence relationship table to the display unit 3. The display unit 3 displays the correspondence relationship table. The verifier may recognize that the fault has been resolved through an intentional correction to the changed logic operation based on the correspondence relationship table displayed on the display unit 3.

Modification 3

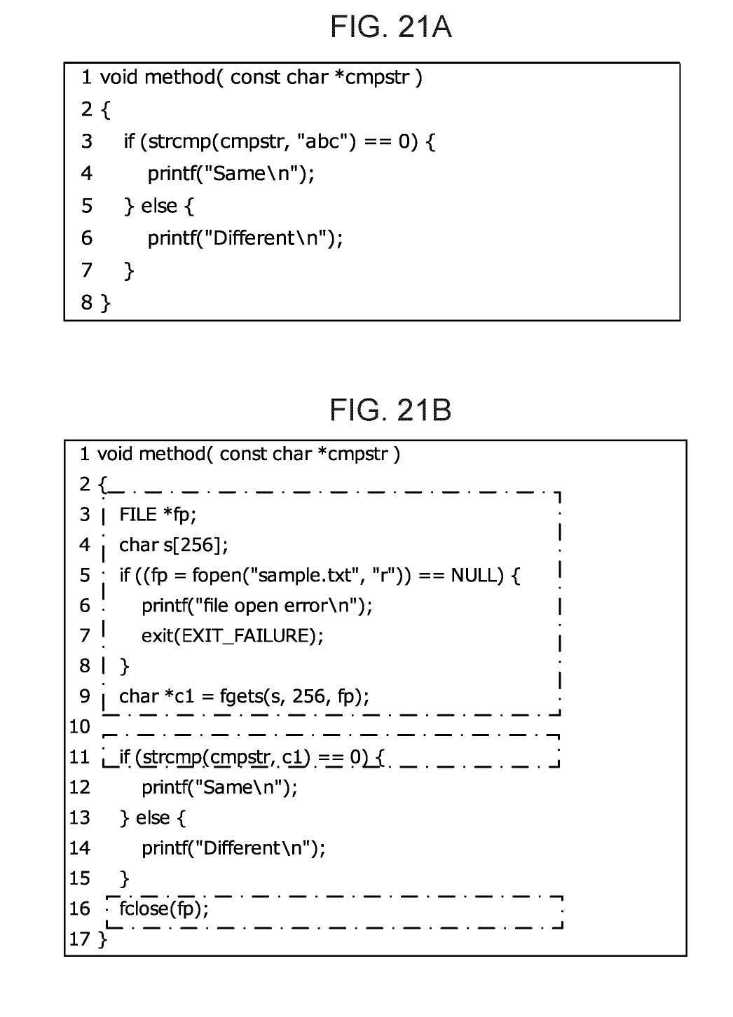

FIG. 21A illustrates an example of prior-to-change source code of modification 3, and FIG. 21B illustrates an example of after-change source code of modification 3. The fifth line of the after-change source code is an instruction for opening a file, and the sixteenth line of the after-change source code is an instruction for closing an opened file.

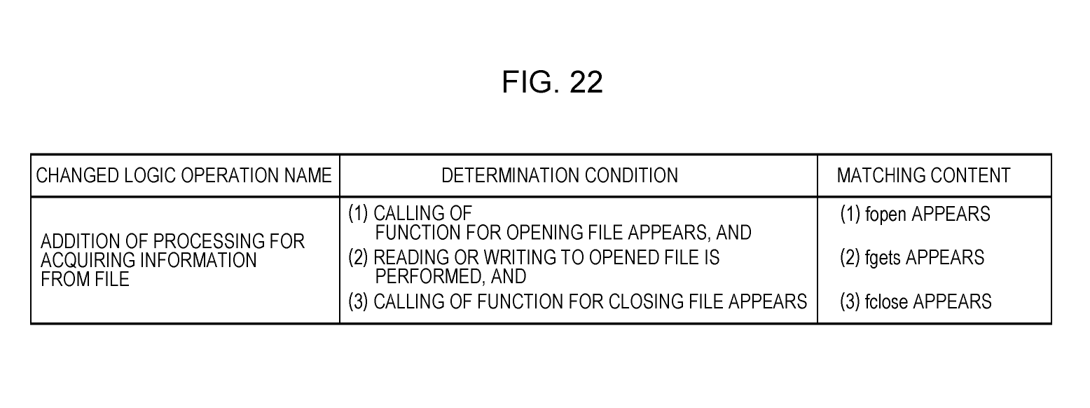

FIG. 22 illustrates an example of a determination table of modification 3. The after-change source code in FIG. 21B matches the determination conditions for “addition of processing for acquiring information from file” among the determination conditions in the determination table.

The analyzing unit 12 performs static analysis on the prior-to-change source code and the after-change source code. As described above, the static analysis includes analysis of character strings and analysis of syntax based on the analysis of the character strings.

FIG. 22 is a diagram illustrating an example of a determination table of modification 3. The determination conditions of the determination table indicate three conditions relating to files. For the instructions relating to files included in the source code, it may be difficult to identify a changed logic operation based on only analysis of character strings.

In modification 3, the analyzing unit 12 is able to identify a changed logic operation of an instruction relating to a file by performing the above-mentioned static analysis on the prior-to-change source code and the after-change source code.

Flowchart Illustrating Example of Flow of Processing of Embodiment

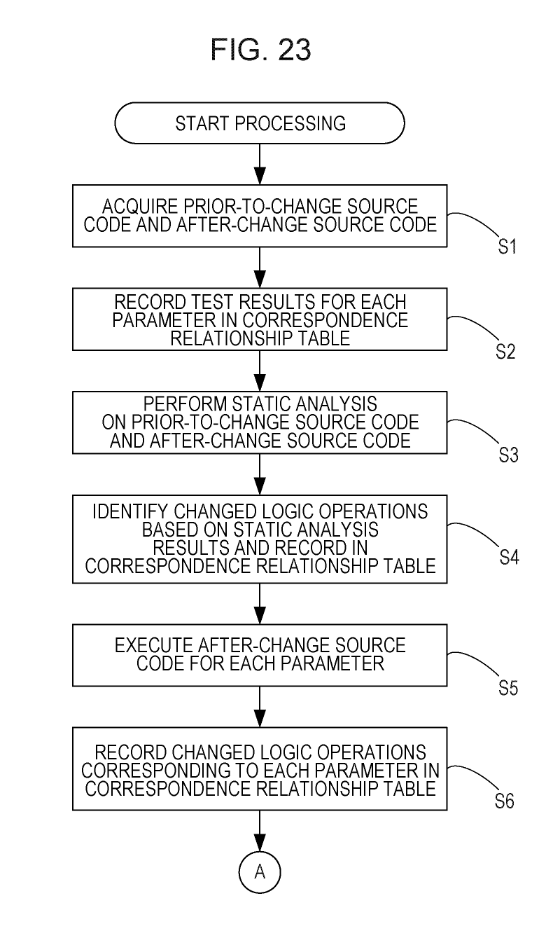

Referring to FIGS. 23 to 25, a flowchart illustrating an example of the flow of processing of an embodiment will be described. The flowchart is also applicable to modifications 1 to 3.

As illustrated in the flowchart in FIG. 23, the acquiring unit 11 acquires the prior-to-change source code and the after-change source code stored in the storage unit 4 (operation S1).

The test-executing unit 13 executes the after-change source code for each of the plurality of parameters, and records the test results corresponding to the respective parameters in the correspondence relationship table in the storage unit 4 (operation S2).

In the case where test results of the prior-to-change source code are not recorded in the storage unit 4, the test-executing unit 13 executes the prior-to-change source code for each of the parameters. The test results are then recorded in the correspondence relationship table in the storage unit 4.

The test-executing unit 13 records the test results of the prior-to-change source code and the test results of the after-change source code in the correspondence relationship table in association with the respective parameters.

The analyzing unit 12 performs static analysis on the prior-to-change source code and the after-change source code (operation S3). Based on the results of the static analysis, the analyzing unit 12 compares analysis data of the prior-to-change source code and analysis data of the after-change source code and identifies logic operations that match the determination conditions in the determination table as changed logic operations.

The analyzing unit 12 records information relating to the identified changed logic operations in the changed logic operation item of the correspondence relationship table (operation S4).

The test-executing unit 13 executes the after-change source code using each parameter (operation S5). Therefore, testing is performed for each parameter. The test-executing unit 13 identifies an executed changed logic operation and records the executed changed logic operation in the correspondence relationship table when executing testing for each of the parameters (operation S6).

At this time, the test-executing unit 13 records the respective parameters and the executed changed logic operations in the correspondence relationship table in the storage unit 4 in association with each other. Therefore, the test results of the prior-to-change source code, the test results of the after-change source code, and the executed changed logic operations are recorded in the correspondence relationship table in association with the respective parameters.

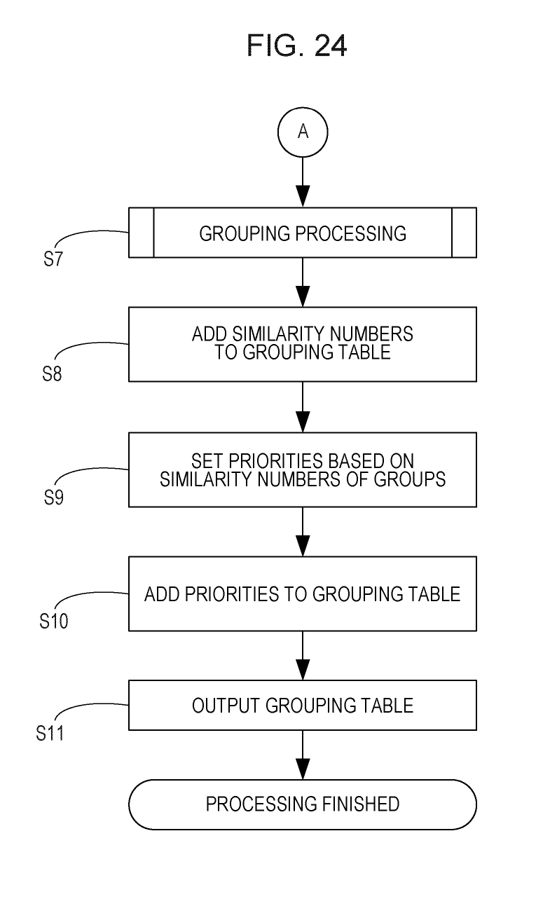

The output unit 15 may output the correspondence relationship table to the display unit 3. In this case, the correspondence relationship table such as that illustrated in the example in FIG. 9 is displayed on the display unit 3. Next, the processing that occurs after “A” will be described while referring to the flowchart in FIG. 24.

The grouping unit 14 performs grouping processing of grouping the parameters in the correspondence relationship table based on differences between the test results of the prior-to-change source code and the after-change source code, and the changed logic operations (operation S7). In addition, the grouping unit 14 adds similarity numbers to the groups in the grouping table (operation S8).

As a result of the grouping processing performed by the grouping unit 14, a plurality of parameters may belong to one group or one parameter may belong to one group. The grouping unit 14 sets the priorities based on the similarity numbers included in the groups (operation S9). The grouping unit 14 adds the priorities to the groups in the grouping table (operation S10).

The output unit 15 outputs the grouping table to the display unit 3 (operation S11). The grouping table is displayed on the display unit 3. The verifier is able to verify the after-change source code based on the grouping table displayed on the display unit 3, and therefore the testing work is more efficient.

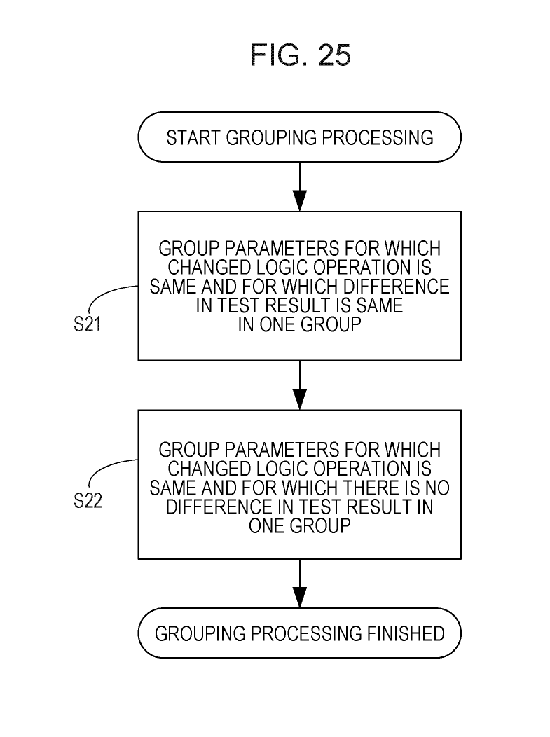

FIG. 25 illustrates an example of the grouping processing. Out of the parameters included in the correspondence relationship table, the grouping unit 14 groups parameters for which the changed logic operation is the same and for which the test result difference is the same into one group (operation S21).

In addition, out of the parameters included in the correspondence relationship table, the grouping unit 14 groups parameters for which the changed logic operation is the same and for which there is no test result difference into one group (operation S22).

Example of Hardware Configuration of Information Processing Device

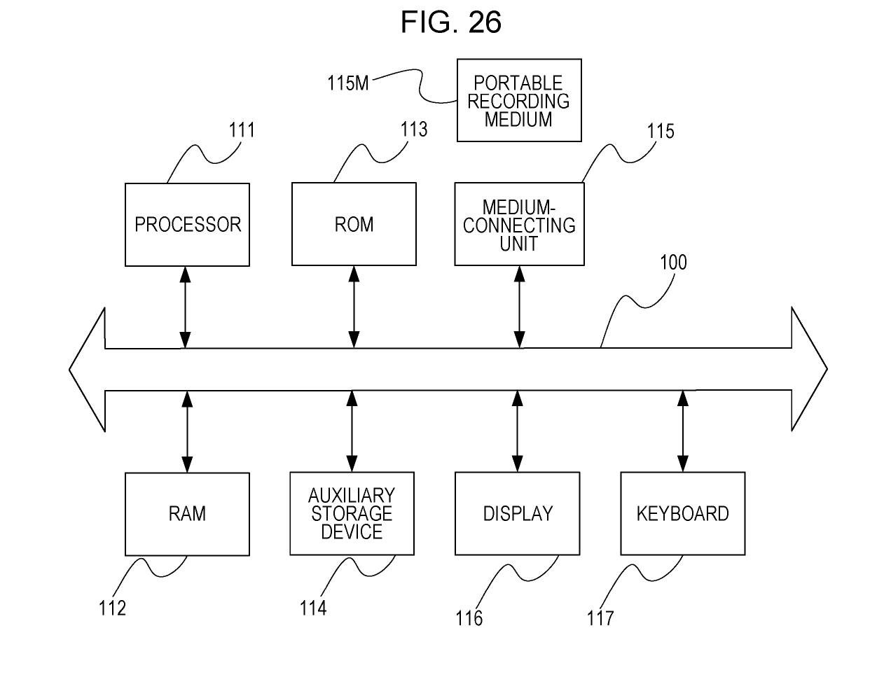

Next, an example of the hardware configuration of the information processing device 1 will be described while referring to an example in FIG. 26. As illustrated in the example in FIG. 26, a processor 111, a random access memory (RAM) 112, and a read only memory (ROM) 113 are connected to a bus 100. In addition, an auxiliary storage device 114, a display 116, and a keyboard 117 are connected to the bus 100.

The processor 111 executes a program expanded in the RAM 112. An output program that performs the processing of the embodiment may be used as the executed program.

The ROM 113 is a non-volatile storage device that stores the program expanded in the RAM 112. The auxiliary storage device 114 is a storage device that stores various information, and a hard disk drive or a semiconductor memory may be used, for example. A medium-connecting unit 115 is provided so as to be connectable to a portable recording medium 115M.

A portable memory (for example, semiconductor memory) or an optical disc (for example, compact disc (CD) or digital versatile disc (DVD)) may be used as the portable recording medium 115M. The output program that performs the processing of the embodiment may be recorded on the portable recording medium 115M.

The above-mentioned control unit 2 may be implemented by executing the provided output program using the processor 111. The display unit 3 may be implemented by the display 116. The storage unit 4 may be implemented by the RAM 112, the auxiliary storage device 114, and the like. The input unit 5 may be implemented by the keyboard 117, a mouse, and the like.

The RAM 112, the ROM 113, the auxiliary storage device 114, and the portable recording medium 115M are examples of computer-readable physical storage mediums. These physical storage mediums are not temporary storage mediums such as signal carriers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable non-transitory recording medium storing a program that causes a computer to execute a procedure that outputs results of a plurality of tests performed on source code, the procedure comprising:
acquiring prior-to-change source code and after-change source code;
comparing the acquired prior-to-change source code and after-change source code;
identifying changed processing content indicating processing content that has changed between the prior-to-change source code and the after-change source code based on results of comparing; and
outputting, in association with the plurality of tests, information indicating test results for the prior-to-change source code, test results for the after-change source code, and changed processing content executed by the plurality of tests for the after-change source code out of the identified changed processing content.

2. The computer-readable non-transitory recording medium according to claim 1, the procedure further comprising:
grouping the plurality of tests based on the test results for the prior-to-change source code, the test results for the after-change source code, and the executed changed processing content; and
outputting information regarding the grouped plurality of tests.

3. The computer-readable non-transitory recording medium according to claim 2, wherein the grouping includes:
causing tests for which the executed changed processing content is same and for which a difference between the test results for the prior-to-change source code and the test results for the after-change source code is same to belong to a first group, and
causing tests for which the executed changed processing content is same and for which there is no difference between the test results for the prior-to-change source code and the test results for the after-change source code to belong to a second group.

4. The computer-readable non-transitory recording medium according to claim 2, the procedure further comprising:
determining a number of tests within each group and adding the determined number to the information regarding the grouped plurality of tests and outputting the information.

5. The computer-readable non-transitory recording medium according to claim 2, the procedure further comprising:
assigning priority information to a plurality of groups creating by the grouping, wherein priorities of the groups increase as a number of tests included in the groups become smaller, the assigned priority information being included in the information regarding the grouped plurality of tests, and outputting the information.

6. The computer-readable non-transitory recording medium according to claim 2, the procedure further comprising:
determining a number of tests within each group and assigning priority information to each group based on the determined number of tests, wherein the assigned priorities of the groups increase as the determined number of tests included in the groups become smaller, the assigned priority information being included in the information regarding the grouped plurality of tests, and outputting the information.

7. The computer-readable non-transitory recording medium according to claim 1, procedure further comprising:
performing static analysis on the after-change source code, and
identifying the changed processing content based on the after-change source code on which the static analysis was performed.

8. The computer-readable non-transitory recording medium according to claim 1, the procedure further comprising:
in a case where abnormal processing content is included in the prior-to-change source code and the abnormal processing content is changed into normal processing content in the after-change source code, adding information indicating the processing content to the information to be output, and the normal processing content is not included in the changed processing content executed by the plurality of tests for the after-change source code out of the identified changed processing content.

9. A computer-implemented output method that outputs results of a plurality of tests performed on source code, the output method comprising:
acquiring prior-to-change source code and after-change source code;
comparing the acquired prior-to-change source code and after-change source code;
identifying changed processing content indicating processing content that has changed between the prior-to-change source code and the after-change source code based on results of comparing; and
outputting, in association with the plurality of tests, information indicating test results for the prior-to-change source code, test results for the after-change source code, and changed processing content executed by the plurality of tests for the after-change source code out of the identified changed processing content, by a processor.

10. An information processing device to identify parameters for verifying source code of a computer program, the information processing device comprising:
a memory configured to store a prior-to-change source code and an after-change source code; and
a processor coupled to the memory and configured to:
acquire the prior-to-change source code and the after-change source code from the memory;
compare the prior-to-change source code and the after-change source code to identify differences in processing content between the prior-to-change source code and the after-change source code;
identify parameters for a plurality of tests to be completed for at least one changed processing content identified based on the differences between the prior-to-change source code and the after-change source code;
perform the plurality of tests on a portion of each of the prior-to-change source code and the after-change source code corresponding to the at least one changed processing content using the identified parameters to obtain test results;
group the tests and corresponding parameters based on the test results into a plurality of groups;
select only one parameter from each group of tests for verifying the updated source code; and
output the selected parameters for verifying the after-change source code.

11. The information processing device according to claim 10, further comprising:
a display configured to display verification information to a user, wherein the verification information includes the output selected parameters for verifying the after-change source code.

12. The information processing device according to claim 10, wherein the at least one changed processing content is at least one changed logic operation.

13. The information processing device according to claim 10, wherein the processing compares the prior-to-change source code and the after-change source code using static analysis including analysis of character strings and analysis of the syntax of the prior-to-change source code and the after-change source code.

14. The information processing device according to claim 10, the processor is further configured to generate a correspondence relationship table, the correspondence relationship table includes a test identifier, a parameter for a test, a prior-to-change test result, an after-change test result, and a determination condition for each of the plurality of tests performed for the at least one changed processing content.

15. The information processing device according to claim 10, wherein the processor
groups tests and corresponding parameters for which a difference between a test result for the prior-to-change source code and a test result for the after-change source code is same within a first group, and
groups tests and corresponding parameters for which there is no difference between the test result for the prior-to-change source code and the test result for the after-change source code within a second group.

16. The information processing device according to claim 15, wherein the processor is further configured to determine a number of tests within each group, and outputs the determined number of tests within each group.

17. The information processing device according to claim 16, wherein the processor is further configured to assign a priority to each of the plurality of groups, and the assigned priority increase as a number of tests included in the groups become smaller.

18. The information processing device according to claim 10, wherein, in a case where abnormal processing content is included in the prior-to-change source code and the abnormal processing content is changed into normal processing content in the after-change source code, a portion of each of the prior-to-change source code corresponding to the abnormal processing content and the portion of the after-change source code corresponding to the normal processing content is not tested by the processor.
